(19) United States
(12) Patent Application Publication
(10) Pub. No.: US 2006/0211418 A1
(43) Pub. Date: Sep. 21, 2006

(54) Method for carrying out a handover

(75) Inventor: Dirk Hofmann, Bietigheim-Bissingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/374,101

(22) Filed: Mar. 14, 2006

(30) Foreign Application Priority Data
Mar. 16, 2005 (EP) 05290589.0

(51) Int. Cl. H04Q 7/20

(52) U.S. Cl. 455/426.1

(57) ABSTRACT

A method for carrying out a handover in a communication network, the communication network having at least a first base station and a second base station, the method comprising the steps of measuring the geographical position of the mobile station while the mobile station communicates with a first base station, comparing the geographical position with data comprising information on the location of geographical regions, whereby the signal quality in these regions is known to be worse than a predefined level, carrying out a handover to the second base station when the mobile station is close to such a region of the first base station. A mobile station and the communication network performing this method, and the software within the mobile terminal.

### BACKGROUND OF THE INVENTION

The invention is based on a priority application EP05290589.0 which is hereby incorporated by reference.

The invention relates to communication networks, and in particular to wireless cellular communication networks. More importantly it refers to methods and devices for initiating a handover when a mobile station comes close to a region which is known to exhibit a poor signal quality for mobile stations. The achievements of the invention facilitate a mobility management in homogeneous and heterogeneous mobile networks.

The radio link quality within radio access networks such as GSM, UMTS or WLAN depends on many factors; some of which can hardly be influenced by the network operator. Multipath reception due to obstacles in the transmission-path and varying atmospheric conditions are just two examples which may lead to a high absorption of the transmitted signal, or to high interference contributions to the received signal. As a consequence, the signal quality encountered by mobile stations varies from place to place. When a mobile station which is connected to a certain base station moves around it may reach such a region with a poor signal quality abruptly. In this case the data rate drops, data packets may be lost, or the connection may break down altogether. In UMTS systems this situation can be avoided by macrodiversity, which means that the mobile station has connections to two or more base stations or cells respectively.

U.S. Pat. No. 6,321,090 B1 discloses a mobile communication system with a position detection to facilitate a hard handover. The cellular system of this US patent determines the position of a mobile station moving from place to place. If it comes in a static handover region defined as the region of overlap between adjacent cells a handover to a another base station is initiated.

### SUMMARY OF THE INVENTION

It is an object of the present invention to provide a method and corresponding devices which make sure that the signal quality received by a mobile station exhibits less pronounced geographical variations.

This object and other objects are solved by the features of the independent claims. Further embodiments of the invention are described by the features of the dependent claims. It should be emphasized that any reference signs in the claims shall not be construed as limiting the scope of the invention.

A first aspect of the invention refers to a method for carrying out a handover in a communication network whereby the communication network has at least a first base station and a second base station. The method comprises the steps of measuring the geographical position of the mobile station while the mobile station communicates with a first base station, comparing the geographical position with data comprising information on the location of geographical regions, whereby the signal quality in these regions is known to be worse than a predefined level with respect to at least one preselected base station, and carrying out a handover to the second base station when the mobile station is close to such a region of the first base station.

This method is based on the idea that obstacles in the transmission path, which are at least partially responsible for unsatisfactory reception conditions, depend on the position of the base station with respect to the mobile station. If a handover to a second base station is carried out the transmission path to the mobile station is changed such that other obstacles within the new transmission path govern the new signal quality. In other words the signal quality at a given location is not an absolute quantity, but is a quantity dependent on the position of the base station with which the mobile station communicates.

However, in order to avoid the problems encountered in the prior art the signal quality after a handover must be better than before. Therefore the signal quality for the geographical area covered by a base station must be known in detail. The geographical area might be a cell of a cellular communication network. More importantly, regions within these geographical areas covered by a preselected base station must be known in which the signal quality is worse than a predefined level. In other words, regions with poor signal quality with respect to a preselected base station must be known.

If these regions are known for the base stations of a communication network a handover can be initiated well before the mobile station enters a region with a poor signal quality. In order to do this the geographical position of the mobile station and thus its proximity to such a region is determined. If the mobile station communicates with a first base station and is close to such a region with a poor signal quality with respect to the first base station, and is thus outside such a region, a second base station is identified which provides a better signal quality in said region. The handover then serves to anticipate a worsening of the radio link quality.

The above-mentioned method avoids a drop in the signal quality caused by situations in which the mobile station enters a region of poor signal quality. The data rate is more constant and a loss of data packets is reduced. Furthermore, a breakdown of the connection is less likely. Another advantage is that the invention facilitates a seamless mobility within and between networks belonging to different communication standards.

A mobile station according to the invention might be a mobile phone, a laptop, a notebook, a PDA or similar electronic devices.

There are at least two ways in which the above-mentioned method is carried out.

In a first alternative mobile station measures its geographical position and transfers this information to the communication network. In order to know which base station might serve the mobile station in the alternative, and might do this with a good signal quality, the mobile station sends the above information to the communication network. Furthermore, the mobile station may complement the above information with measurement results of the signal quality of the serving cell and neighbor cells to the communication network. The communication network determines the proximity of the mobile station to a geographical region with poor signal quality. The last step assumes that the communication system knows where these geographical regions are located. When the mobile station is close to such a region the communication network carries out the handover when the mobile station is close to it. Normally, this is done by a base station controller controlling the operation of a multitude of base stations. In the alternative this is done by a base station.

In a second alternative the mobile station knows where the geographical regions of poor signal quality with respect to a preselected base station are located. The corresponding data is stored in a storage memory of the mobile station, and the mobile station measures its geographical position. It determines the proximity to a geographical region with poor signal quality with the help of the data which is stored in its storage memory. If it comes close to such a region the mobile station sends a request for a handover to the communication network. In order to know which base station might serve the mobile station in the alternative, and might do this with a good signal quality, the mobile station may perform measurements on the serving link and appropriate links of neighbor cells and may complement the request for a handover with these measurement results. Then the network automatically performs a handover, or simply uses this request as one additional parameter in the decision whether a handover should be performed or not.

Furthermore the method described above can be carried out in homogenous networks as well as in heterogeneous networks. In the first case the first base station and the second base station satisfy the same standard for communication networks. As an example, both base stations provide UMTS services. In the second case the base stations satisfy different standards for communications systems. As an example, the first base station provides UMTS services, and the second base station belongs to a WIMAX system or a WLAN system.

In the above-mentioned second alternative for carrying out the method according to the invention the data is stored in a storage memory of the mobile station. In order to limit the memory space needed for that purpose it is suggested that the data stored in the mobile station refers to a geographical area of predefined spatial extension, and that the mobile station is located in this geographical area. The size of this geographical area can be chosen to be smaller or larger depending on the memory space available. For practical reasons it will only refer to a small area if the mobile station is always used in the same area, for example between home and place of employment. To save memory space only base stations with the same radio access technologies the mobile station can use might be stored in the memory space. The geometrical shape of the geographical area might be chosen according to the needs and may be cell-like.

For practical reasons it might be desirable that the data covers a large geographical area such as a whole country in cases when the mobile station is used by a highly mobile owner. On the other hand it is desirable that a mobile station only stores data limited to a certain region as explained in the last paragraph. Both needs can be accomplished by storing the data within the communication network, and updating the data of the mobile station accordingly.

All data might be on a central server of the communication network, or may be on a multitude of servers distributed over the network. In the latter case each of the servers might be associated with a base station controller, whereby the data each refers to the geographical area covered by such a base station controller.

Updating the data of the mobile station might be necessary because the mobile station has moved and reaches the boundary of the geographical area covered by its data.

Updating may also be necessary because the signal quality has permanently changed within the geographical area covered by the data stored in the mobile station. A permanent change might be due to new obstacles in the transmission path of base stations located in the proximity of the mobile station. These obstacles may be new buildings which change the signal quality as explained above. A permanent change may also be due to a change in the infrastructure of the communication network. The position of the antennas of a base station might have been re-collocated or further antennas or new base stations/access points might have been installed. In the case of permanent changes the data is updated when the signal quality within the geographical area covered by the data has changed. This can be done when the signal traffic is low such as during the night.

As mentioned above one possibility to carry out the method according to the invention is that the mobile station stores appropriate data and requests a handover to a second base station. Accordingly, another aspect of the invention is a communication network which has means for carrying out a handover from a first base station to a second base station upon request from a mobile station.

According to the prior art the radio network controller (RNC) is responsible for handovers in the case of UMTS systems. For carrying out the invention the RRC signaling protocol between the mobile station and the RNC has to be extended. The extension would allow for transmitting GPS positions and for transmitting data information (GPS positions, received and transmitted power, base station ID) which have been collected in the mobile station for a certain time period. Furthermore, the handover management (request for strengthened measurements near geographical areas of poor signal quality) and the handover decision function (distance between a mobile station and the above-mentioned geographical regions must be considered) within the RNC have to be modified. An additional storage memory for the database is required in the base station controller. Finally, a comparison unit (mobile station position to position of geographical area) has to be added to the base station controller.

Another aspect of the invention refers to a mobile station. The mobile station has means for identifying its geographical position and means for storing data. Furthermore it has a computer program or a firmware for carrying out the following steps:

a) measuring the geographical position of the mobile station, said mobile station communicating with a first base station,

b) comparing the geographical position with data from the storage means, said data comprising information on the location of geographical regions, whereby the signal quality in such a region is known to be worse than a predefined level with respect to at least one preselected base station,

c) requesting a handover from the communication network if the mobile station comes closes to such a region of the first base station.

Many types of means for identifying a geographical position are known in the prior art. They can be used for the purposes of the present invention when they provide an absolute geographical position such as a latitude (for example 48° 46′ 36″) and a longitude (for example 9° 10′ 48″). A preferred and well known system is the Global Positioning System (GPS). An even better system offering a higher resolution is the future European global positioning system which is currently called Galileo.

It goes without saying that the above-mentioned steps a), b), and c) can be carried out by individual program modules of a single computer program or by individual programs. In the latter case the totality of these individual programs should be understood to represent a (single) computer program in the sense of the present invention.

Preferably, the mobile station performs strengthened measurements on available neighbor cells after step b) if the mobile station comes closes to such a region of the first base station. Then it can request a handover from the communication network if the received signal quality of neighbor cells is sufficient to take over the service.

In the prior art a mobile station performs measurements of the signal quality received from different base stations and sends this data to the communication network such that the base station controller can decide which base station should communicate with this device. According to the invention, this data, together with the geographical position of the point of measurement is preferably collected within the mobile station for a certain time period, and is transferred to the communication network in order to collect the data necessary for carrying out the present invention. According to the invention the following data can be transmitted on demand and can be sent in times of low traffic load:

a) the signal quality of the serving link received by the mobile station

b) the power, which has been transmitted at the base station (the currently used transmit power can be communicated to the mobile stations on a broadcast channel or a beacon)

c) the geographical position at which the signal quality was measured

d) the base station from which the mobile station received the signals, and which yielded the above signal quality.

A network entity within the communication network collects the above data from all mobile stations for a geographical position, calculates the ratio between received and transmitted power and does an averaging. The collected data are

a) the averaged ratio value of the signal quality

b) the geographical position at which the signal quality was measured

c) the base station from which the mobile station received the signals, and which yielded the above signal quality.

According to another aspect of the invention the data is configured to be a database. The database is stored on a computer readable medium and comprises the data mentioned in the last paragraph.

In a preferred embodiment of the database it also comprises the locations of regions where the signal quality with respect to a certain base station is poor. Each geographical region may be approximated by at least one circle, such that the database contains the position of the centre of the circle and its diameter or radius.

One possibility to create the database is to provide a storage means for the data and by adding data received from mobile stations. In the prior art mobile stations determine the signal quality of the serving link at their location periodically. This data, the geographical position of the mobile station in the moment of collecting these data, and an identification of the base station from which signals have been received and evaluated with respect to their quality, are thus transferred to the storage means.

The availability of the data base offers also new opportunities to optimize the communication network. The data can be used for simulator calculations required for a more efficient dimensioning of the network.

These and other aspects of the invention will be apparent from and elucidated with reference to the embodiments described thereafter. It should be noted that the use of reference signs shall not be construed as limiting the scope of the invention.

### BRIEF DESCRIPTION OF THE DRAWINGS

FIG. 1 shows a communication network according to the prior art,

FIG. 2 shows a geographical area covered by the network,

FIG. 3 schematically shows a mobile station

FIG. 4 schematically shows a communications system.

### DETAILED DESCRIPTION OF THE DRAWINGS AND THE PREFERRED EMBODIMENTS

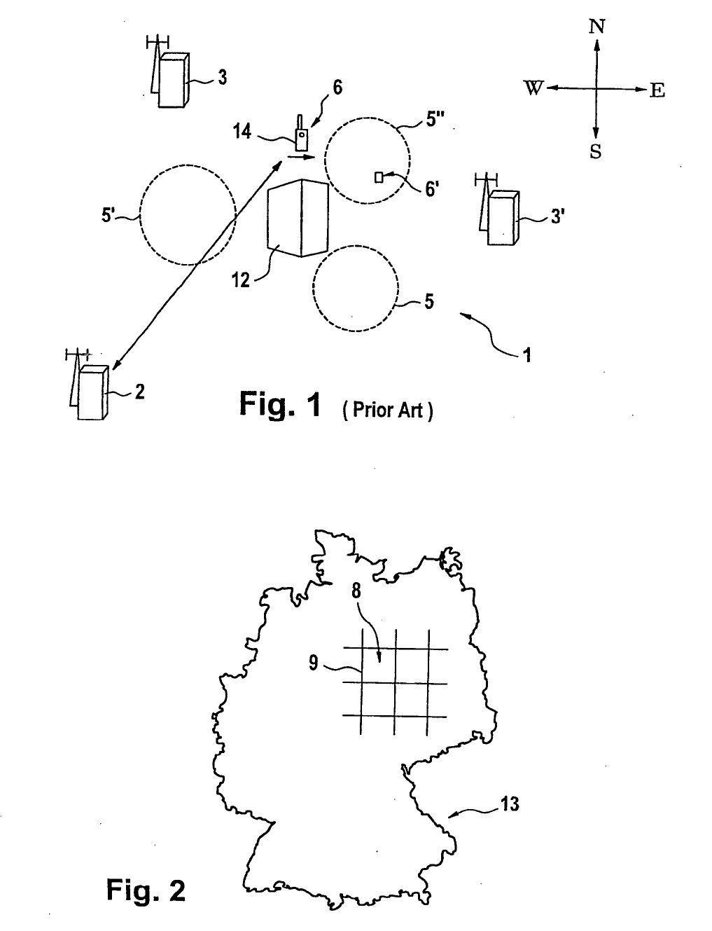

FIG. 1 shows a communication network according to the prior art. The UMTS network 1 comprises a multitude of base stations (node B). For sake of simplicity, only three base stations denoted by 2, 3 and 3′ are shown in FIG. 1. The UMTS network covers a whole country 13 as shown in FIG. 2, whereby the coverage within the country 13 is subdivided into geographical areas 8. In FIG. 2 the areas 8 represent a chess-like structure, whereby only a small portion is shown for simplicity.

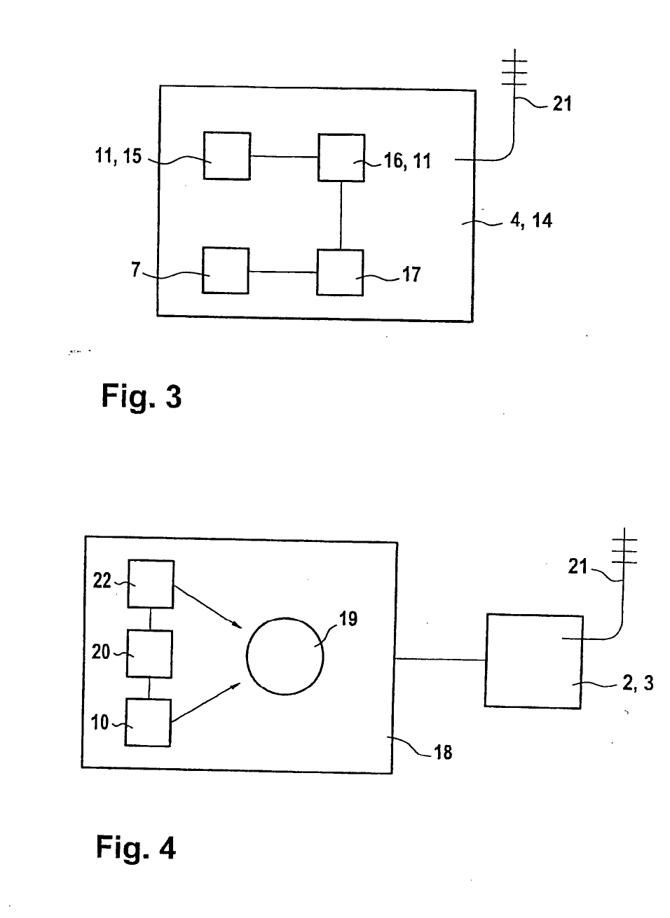

A mobile station 14 has established a connection to node B 2, which is indicated by the arrow between node B 2 and mobile station 14. It is carried eastward by its owner, as it is indicated by the arrow below the mobile station 14. Mobile station 14 has a GPS system, with which its geographic position 6 can be identified. Furthermore, it contains a storage memory 7, cf. FIG. 3, with a database. The database contains the location of geographical regions 5, 5′, 5″, whereby the signal quality in such a region is known to be worse than a predefined level with respect to at least one preselected base station. In the example of FIG. 1, the database thus knows
the location of a geographical region 5, and the fact that the signal quality in this region is poor when a connection to node B 3 exists,
the location of a geographical region 5′, and the fact that the signal quality in this region is poor when a connection to node B 3′ exists,
the location of a geographical region 5″, and the fact that the signal quality in this region is poor when a connection to node B 2 exists.

As can be derived from FIG. 1, the reason for the poor signal quality in the regions 5, 5′ and 5″ is the building 12. This building 12 represents an obstacle in the transmission paths from the node Bs 3, 3′ and 3″ to regions 5, 5′ and 5″ respectively.

FIG. 3 shows a mobile station 14 in a schematic way. It comprises a GPS sensor 15, which sends the received signals to a GPS logic 16 to identify the position of the mobile station. This information is transferred to microprocessor 17, which has access to a database stored in storage memory 7. The database contains information of the location of regions 5, 5′ and 5″ and the node Bs associated with these regions. When the mobile station 14 moves eastward in FIG. 1, it comes close to region 5″, in which the signal quality is poor when the mobile station 14 is connected to node B 2. Consequently, there is the risk that the radio link quality becomes worse abruptly, or that the connection breaks down altogether.

The mobile station 14 calculates the shortest distance from its own position 6 to region 5″. This may be done constantly, or in a repetitive fashion. For doing that, is uses the location of the centre of the region 5″, which is approximated by a circle, and the diameter of the circle from the database stored in the mobile station 14. If it comes sufficiently close to region 5″ it starts measuring the signal strengths received from other node Bs such as node B 3 or node B 3′ and transmits these measurement values in combination with a handover request to node B 2. A base station controller 19, cf. FIG. 4, decides to perform the handover as requested by the mobile station 14. This is done by a handover unit 10 which instructs the CDMA interconnect system 19 of base station controller 19 accordingly. Taking account of the above measurement values it decides to arrange a handover to node B 3.

The mobile station 14 may move into region 5″. Due to the pre-emptive handover the signal quality within this region, for example at the new position 6′, is far better than without the handover. The reason is that region 5″ is not a shadowed region for new node B 3.

FIG. 4 shows that the base station controller 19 may also have a database 22 with the locations of regions of poor signal quality, such as regions 5, 5′ and 5″. In this case the mobile station 14 informs its associated node B only of its position. A comparison unit 20 calculates the shortest distance from the current position 6 to a region of poor signal quality such as region 5″. If the mobile station comes close to region 5″ the base station controller requests the mobile station to deliver measurement results of the signal quality of node B 3 and node B 2. Then, the base station controller 19 may decide to do a handover to the neighbouring cell with the best signal quality.

### List of Reference Numerals

01 communication network

02 first base station

03 second base station

04 mobile station

05 geographical region with poor signal quality

06 geographical position of mobile station

07 storage memory

08 geographical area

09 boundary of geographical area

10 means for carrying out a handover

11 location identification means

12 building

13 country

14 mobile station

15 GPS sensor

16 GPS logic

17 microprocessor

18 base station controller

19 CDMA interconnect system

20 comparison unit

21 antenna

22 database

1. Method for carrying out a handover in a communication network, the communication network having at least a first base station and a second base station, the method comprising the following steps:
a) measuring the geographical position of the mobile station while the mobile station communicates with a first base station,
b) comparing the geographical position with data comprising information on the location of geographical regions, whereby the signal quality in such a region is known to be worse than a predefined level with respect to at least one preselected base station,
c) carrying out a handover to the second base station when the mobile station is close to such a region of the first base.

2. The method according to claim 1, characterized in that after step b) strengthened measurements on the signal quality of a second base station are carried out if the mobile station comes close to such a region of the first base station, and that the handover is performed if the quality of signals from the second base station is sufficient to take over the service.

3. The method according to claim 1, characterized in that the first base station and the second base station satisfy same or different standards for communications systems, and particularly refer to UMTS systems, WIMAX systems, or WLAN systems.

4. The method according to claim 1, characterized in that the mobile station measures its geographical position and transfers this information to the communication network, that the communication network determines the proximity of the mobile station to a geographical region with poor signal quality, and that the communication network carries out the handover when the mobile station is close to such a region.

5. The method according to claim 1, characterized in that the data is stored in a storage memory of the mobile station, that the mobile station measures its geographical position and that it determines its proximity to a geographical region with poor signal quality with the help of the data which is stored in its storage memory, and that the mobile station requests a handover from the communication network if it comes close to such a region.

6. The method according to claim 4, characterized in that the data stored in the mobile station refers to a geographical area of predefined spatial extension, and that the mobile station is located in this geographical area.

7. The method according to claim 6, characterized in that the data is updated when the mobile station reaches the boundary of the geographical area.

8. The method according to claim 6, characterized in that the data is updated when the signal quality has permanently changed within the geographical area.

9. Mobile station, with means for identifying its geographical position, with means for storing data, and with a computer program for carrying out the following steps:
a) measuring the geographical position of the mobile station, said mobile station communicating with a first base station,
b) comparing the geographical position with data from the storage means, said data comprising information on the location of geographical regions, whereby the signal quality in such a region is known to be worse than a predefined level with respect to at least one preselected base station,
c) requesting a handover to the second base station from the communication network if the mobile station comes close to such a region of the first base station.

10. The mobile station according to claim 9, characterized in that after step b) strengthened measurements on the signal quality of a second base station are carried out if the mobile station comes close to such a region of the first base station, and that the handover is performed if the signal quality of the second base station is sufficient to take over the service.

11. The mobile station according to claim 9, characterized in that it is adapted to transfer data to the communication network, said data comprising
a) geographical positions,
b) the signal quality measured by the mobile station at said geographical positions
c) the power, which has been transmitted at the base station, and
d) identifications of the base stations from which the corresponding signals were received.

12. Method of creating a database, said method comprising the following steps:
a) providing a storage means for the data, said storage means being part of a communication network,
b) adding data received from mobile stations, said data comprising geographical positions, the signal quality mobile stations encounter at said geographical positions, and an identification of the base station corresponding to the signal quality.

13. The method according to claim 1 2, characterized in that geographical regions are defined in which the signal quality is worse than a predefined level with respect to at least one preselected base station, and that the locations of the geographical regions are added to the database.

14. A computer program product comprising a computer readable medium, having thereon computer program code means which, when said program is loaded, make a computer execute the following steps:
a) measuring the geographical position of a mobile station, said mobile station communicating with a first base station of a communication network,
b) comparing the geographical position with data comprising information on the location of geographical regions, whereby the signal quality in these regions is known to be worse than a predefined level with respect to at least one preselected base station,
c) requesting a handover to a second base station if the mobile station comes close to such a region of the first base station.
